(19) United States
(12) Patent Application Publication
(10) Pub. No.: US 2008/0101171 A1
(43) Pub. Date: May 1, 2008

(54) Optical head and disk drive apparatus

(75) Inventor: Tadashi Satou, Kobe-shi (JP)

Correspondence Address: OLIFF & BERRIDGE, PLC, P.O. BOX 320850, ALEXANDRIA, VA, 22320-4850, US

(73) Assignee: FUJITSU TEN LIMITED, KOBE-SHI (JP)

(21) Appl. No.: 11/976,393

(22) Filed: Oct. 24, 2007

(30) Foreign Application Priority Data
Oct. 27, 2006 (JP) 2006-292802

(51) Int. Cl. G11B 7/00

(52) U.S. Cl. 369/44.14

(57) ABSTRACT

The present invention relates to an optical head for carrying out recording and/or reproduction of data on/from an information record disk. For enhancing the degree of freedom of design and reliably and easily ensuring an installation space for a mechanism made to move an optical element linearly, the optical head includes a holder for holding an optical element, a feed screw for moving the holder linearly and a drive unit for driving the feed screw, and the feed screw is placed to make a predetermined angle with respect to a linearly moving direction of the holder.

### BACKGROUND OF THE INVENTION

1) Field of the Invention

The present invention relates to a disk drive apparatus for carrying out the recording/reproduction of data on/from an information record disk (for example, optical disk), and more particularly to an optical head.

2) Description of the Related Art

In recent years, an optical disk serving as an information record disk (an information recording disk) has come into much widespread use as a medium for recording a large variety of data such as video data, audio data and computer data, and the demand for higher density and larger capacity has increasingly taken place with respect to the optical disk.

An optical head (optical pickup device), which is for carrying out the recording and/or reproduction of data with respect to an optical disk, is designed to apply light onto a recording layer of the optical disk for the data recording/reproduction, and the optical disk has, on its own signal recording layer, a cover layer which allows the transmission of light so that light projected from the optical head passes through the cover layer and reaches the signal recording layer. Accordingly, an objective lens of the optical head is designed such that the spherical aberration on the signal recording layer reaches a minimum when the thickness of the cover layer of the optical disk stands at a standard value of specification values.

For this reason, a spherical aberration occurs in a case in which irregularities in thickness of the cover layer happen at manufacturing.

In addition, an objective lens designed for an optical disk having a single signal recording layer on its one-sided surface cannot handle an optical disk having a plurality of signal recording layers on its one-sided surface.

Still additionally, in the case of an optical head made to carry out the recording/reproduction of data on/from a blu-ray disk (registered trademark), since the NA (Numerical Aperture) of an objective lens stands at a high value, the spherical aberration is easy to occur.

Therefore, so far, as shown in FIG. 5, for a correction of the spherical aberration in an optical head 100, a collimating leans or intermediate relay lens (in this case, a collimating lens 102) for allowing a parallel beam to be incident on an objective lens 101 has been configured to be movable in directions of an optical axis of laser light from an LD (Laser Diode) 103. In FIG. 5, a collimating lens 102′ indicated by a broken line is the collimating lens 102 moved.

Moreover, in the optical head 100, the laser light emitted from the LD 103 is irradiated onto an optical disk by passing through a prism 104, a PBS (Polarization Beam Splitter) 105, a collimating lens 102, a ¼ wave plate 106, a reflecting mirror 107 and the objective lens 101, in order. Still moreover, the reflected light from the optical disk is inputted to a PD (Photo Detector) 110 bypassing through the PBS 105, a reflecting mirror 108, a cylindrical lens (which will hereinafter to be referred to simply as a cylindrical) 109 and the prism 104, in order. With this configuration, the optical head 100 carries out the reading/writing of data on an optical disk.

Yet moreover, the optical head 100 corrects the spherical aberration in a manner such that light emitted from the collimating lens 102 (i.e., incident light on the objective lens 101) is changed to convergent light or diffused light by moving the collimating leans 102.

Concretely, in a case in which the cover layer of an optical disk is thinner than the design standard, the collimating lens 102 is shifted so that convergent light is incident on the objective lens 101. This offsets the spherical aberration occurring because the thickness of the cover layer becomes thinner than the design standard, by a spherical aberration occurring in the objective lens 101, thereby achieving a substantially aberration-free condition in the signal recording layer.

On the other hand, in a case in which the cover layer of the optical disk is thicker than the design standard, the collimating lens 102 is shifted so that diffused light is incident on the objective lens 101, thereby achieving an aberration-free condition in the signal recording layer.

In this connection, as different techniques of overcoming the spherical aberration by shifting an optical element, there have been proposed a technique in which a beam expander is located, for example, between a collimating lens and an objective lens, and this beam expander is shifted in directions of an optical axis so as to eliminate the spherical aberration, and a technique in which the distance between two lenses constituting a beam expander is varied in directions of an optical axis so as to overcome the spherical aberration (for example, see the following Patent Document 1).

Referring to FIG. 6, a description will be given hereinbelow of a concrete movable mechanism of the collimating lens 102 in the above-mentioned conventional optical head 100 shown in FIG. 5. In FIG. 6, the respective elements of the optical head 100 are mounted on a base 100a and the objective lens 101 is held by a movable holder (objective lens actuator) 111.

In addition, as shown in FIG. 6, the collimating lens 102 is held by a holder 112 and this holder 112 is configured to be linearly movable in directions (see both arrows x) of an optical axis in a state guided by a guiding main shaft 113.

That is, the holder 112 is guided by the guiding main shaft 113 and brought into contact with a screw thread flank (thread groove) of a feed screw 115 connected to a drive motor 114 so that the holder 112 holding the collimating lens 102 is linearly moved along the guiding main shaft 113 in a manner such that the feed screw 115 is rotationally driven by the drive motor 114.

Meanwhile, as shown in FIGS. 5 and 6, in the optical head 100, there is a need to arrange the plurality of optical elements 101, 102 and 105 to 108 serially along a straight line, and further, there is a need to arrange the drive motor 114 and the feed screw 115, which enable the collimating lens 102 (holder 112) to be movable in the directions of the optical axis, in parallel with the plurality of optical elements 101, 102 and 105 to 108. This extremely reduces the degree of freedom (flexibility) of the design of the optical head 100, particularly makes it difficult to secure the installation space for the drive motor 114.

That is, as shown in FIG. 6, the drive motor 114 is naturally required to be located in the vicinity of the movable holder 111 for the objective lens 101 and, hence, it is difficult to secure the installation space and further there is a possibility that the range Q indicated by a broken line interferes with the movable range of the movable holder 111.

Although it is preferable that the drive motor 114 to be used has a large external shape capable of providing a large driving force, because of the above-mentioned problems in the degree of freedom of design and the installation space, the conventional optical head 100 encounters the restriction on the enhancement of the driving force of the drive motor 114.

In addition, as shown in FIG. 7, the optical head 100 is provided on a disk drive apparatus 120 to be linearly movable in radial directions of an optical disk 130, i.e., in the directions indicated by both arrows y between an inner circumference side (see the optical head 100 shown by a broken line in the illustration) of the optical disk 130 and an outer circumference side (see the optical head 100 shown by a solid line in the illustration). That is, the optical head 100 is formed to be locatable at a corner of the disk drive apparatus 120 (more concretely, a mechanism base 121) having a rectangular parallelepiped configuration surrounding the optical disk 130.

Accordingly, it is also very difficult to change the configuration of the base 100a in order to improve the degree of freedom of the design and secure the installation space for the drive motor 114 in the optical head 100.

[Patent Document 1] Japanese Patent Laid-Open No. 2003-045068

### SUMMARY OF THE INVENTION

The present invention has been developed in consideration of these problems, and it is therefore an object of the invention to improve the degree of freedom of the design of an optical head made to carry out the recording and/or reproduction of data on/from an information record disk and reliably and easily ensure the installation space for a mechanism made to move an optical element linearly.

For achieving this purpose, an optical head according to the present invention comprises a holder for holding an optical element, a feed screw for moving the holder linearly and a drive unit for driving the feed screw, the feed screw is placed to make a predetermined angle with respect to the linearly moving direction of the holder.

Preferably, a contact portion of the holder which is brought into contact with a thread groove of the feed screw is made to extend in parallel or in substantial parallel with the thread groove.

In addition, preferably, the length in the extending direction of the contact portion of the holder which is brought into contact with the thread groove of the feed screw is set on the basis of the predetermined angle and a distance of the linear movement of the holder.

Still additionally, preferably, the direction of the thread groove of the feed screw is perpendicular or substantially perpendicular to the linearly moving direction.

Moreover, preferably, the direction of the thread groove of the feed screw is perpendicular or substantially perpendicular to the linearly moving direction and the length n in the extending direction of the contact portion of the holder which is brought into contact with the thread groove of the feed screw is set on the basis of the predetermined angle α and the linear movement distance m of the holder so as to satisfy the following equation (1),

n≧m×tan α (1).

Still moreover, preferably, the optical head has a guide shaft for guiding the linear movement of the holder.

Yet moreover, preferably, the optical element is a collimating lens located between a light source for emitting laser light to be projected onto an information record disk and an objective lens for collecting or condensing the laser light onto an information recording surface of the information record disk.

Furthermore, for the above-mentioned purpose, a disk drive apparatus according to the present invention comprises an optical head for carrying out recording and/or reproduction of data on/from an information record disk and a first feed screw for linearly moving the optical head, wherein the optical head includes a holder for holding an optical element, a second feed screw for moving the holder linearly and a drive unit for driving the second feed screw, with the second feed screw is placed to make a predetermined angle with respect to a linearly moving direction of the holder.

Thus, according to the present invention, since a feed screw (second feed screw) is placed at a predetermined angle with respect to a linearly moving direction of a holder, unlike the above-mentioned conventional optical head, the holder holding an optical element is linearly movable with reliability by driving the feed screw by a drive unit without locating the feed screw in parallel with the linearly moving direction of the holder. This can improve the degree of freedom (flexibility) of design of an optical head and reliably and easily ensure the installation space for a mechanism made to shift the optical element linearly.

That is, since the feed screw can be placed to make a predetermined angle with respect to the linearly moving direction while the holder is made to be linearly movable, the installation space for the driving unit, which is for driving the feed screw, can be changed from a place where optical elements close up in the linearly moving direction to a place where the size of the driving unit is enlargeable. This can facilitate the design and formation of the optical head.

### BRIEF DESCRIPTION OF THE DRAWINGS

FIG. 1 is an illustration of a configuration of a disk drive apparatus according to an embodiment of the present invention;

FIG. 2 is an illustration of an essential part of an optical head of the disk drive apparatus according to the embodiment of the present invention;

FIG. 3 is a cross-sectional view taken along a line A-A′ in FIG. 2;

FIG. 4 is an illustration useful for explaining a contact state of a movable holder of the optical head of the disk drive apparatus with a second feed screw according to the embodiment of the present invention;

FIG. 5 is an illustration of an example of a configuration of a conventional optical head;

FIG. 6 is an illustration of an essential part of a configuration of a conventional optical head; and

FIG. 7 is an illustration of a disk drive apparatus in which a conventional optical head is mounted.

### DESCRIPTION OF THE PREFERRED EMBODIMENTS

Referring to the drawings, a description will be given hereinbelow of an embodiment of the present invention.

### [1] About Embodiment of the Present Invention

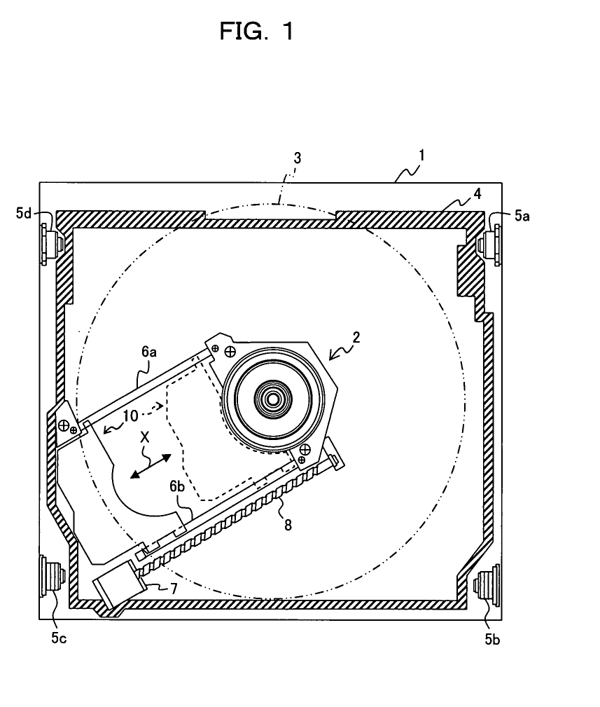

FIG. 1 shows a configuration of an essential part of a disk drive apparatus 1 according to an embodiment of the present invention. As shown in FIG. 1, this disk drive apparatus 1 has a rectangular parallelepiped configuration surrounding an optical disk (information record disk) 3 set on a spindle motor section 2, and an optical head (optical pickup device) 10 is located at a corner of a mechanism base 4 shaped into a generally rectangular configuration along with the external shape of the disk drive apparatus 1.

The spindle motor section 2 is for rotating the optical disk 3 mounted thereon.

Each of dampers 5a to 5d is for absorbing impact against the mechanism base 4.

The optical head 10 is for carrying out the recording and/or reproduction of data on/from the optical disk 3 and is provided to be linearly movable from an inner circumference side (i.e., center side) of the optical disk 3, fixedly secured to the spindle motor section 2 to be rotatable, to an outer circumference side thereof.

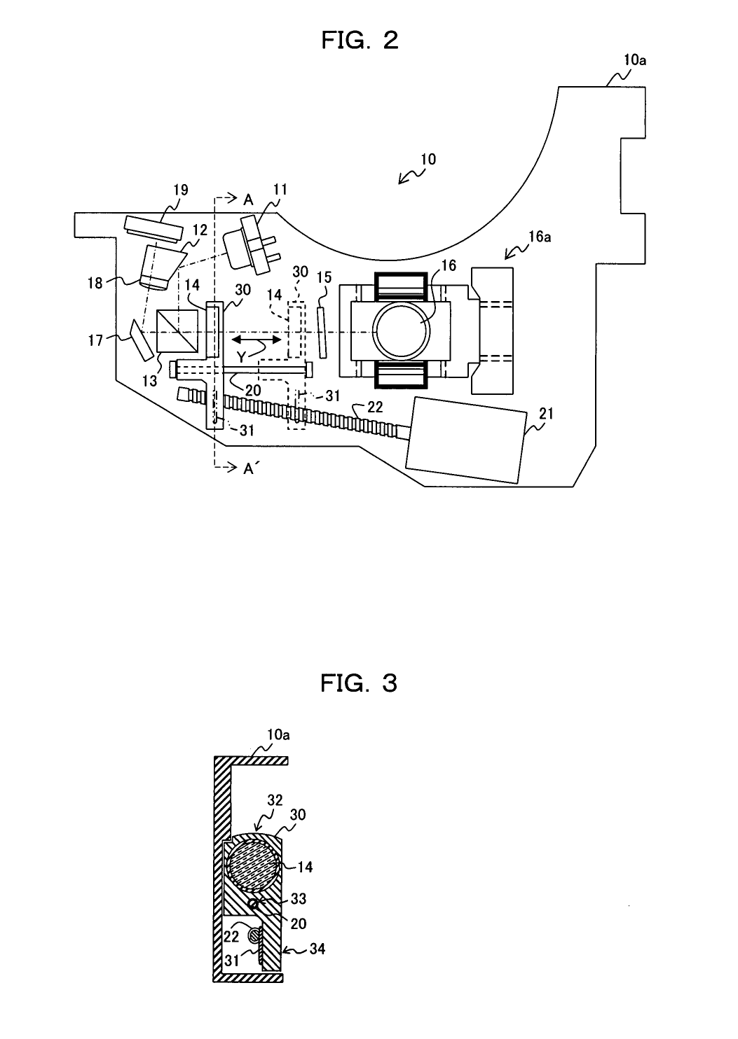

Concretely, a base 10a (see FIG. 2) of the optical head 10 comes into contact with a screw thread flank (thread groove) of a first feed screw 8 connected to a first drive motor 7, and the first feed screw 8 is rotationally driven by the first drive motor 7, thereby linearly moving the optical head 10 in directions indicated by both arrows X in a state guided by a first guide shaft 6a and a second guide shaft 6b.

That is, the optical head 10 is designed to be linearly movable within a range from an inner circumference side of the optical disk 3 indicated by a broken line in the illustration to an outer circumference side thereof indicated by a solid line in the illustration.

FIG. 2 shows a configuration of an essential part of the optical head 10. As FIG. 2 shows, the optical head 10 has, on the base 10a, an LD (Laser Diode; light source) 11, a prism 12, a PBS (Polarization Beam Splitter) 13, a collimating lens 14, a ¼ wave plate 15, an objective lens 16, a reflecting mirror 17, a cylindrical lens (which will hereinafter referred to simply as a “cylindrical”) 18, a PD (Photo Detector) 19, a third guide shaft (guide shaft) 20, a second drive motor (drive unit) 21 and a second feed screw (feed screw) 22.

In the optical head 10, laser light emitted from the LD 11 is projected onto the optical disk 3 by passing through the prism 12, the PBS 13, the collimating lens 14, the ¼ wave plate 15 and the objective lens 16 in order. In FIG. 2, an alternate long and short dash line shows an optical axis of the laser light.

Moreover, between the ¼ wave plate 15 and the objective lens 16, there is provided a reflecting mirror (not shown) whereby light passing through the ¼ wave plate 15 is incident on the objective lens 16.

Still moreover, the objective lens 16, which is for collecting laser light onto an information recording layer of the optical disk 3, is held in a movable holder (objective lens actuator) 16a.

The reflected light of the laser light projected from the objective lens 16 onto the information recording surface (layer) of the optical disk 3 is inputted to the PD 19 by passing through the objective lens 16, the ¼ wave plate 15, the collimating lens 14, the PBS 13, the reflecting mirror 17, the cylindrical 18 and the prism in order.

With this configuration, the disk drive apparatus 1 reads/writes data on the optical disk 3 by using the optical head 10.

The collimating lens 14 is for incident a parallel beam to the objective lens 16, and it is held by a movable holder (holder) 30.

The movable holder 30 is located to be linearly movable in directions of an optical axis (see an alternate long and short dash line in the illustration) of the laser light emitted from the LD 11 and passing through the collimating lens 14.

Concretely, the movable holder 30 has a contact portion (convex portion) 31 which comes into contact with a screw thread flank (inclined surface of a thread groove; thread groove) of the second feed screw 22 connected to the second drive motor 21, and when this contact portion 31 is brought into contact with the second feed screw 22 and the second feed screw 22 is rotationally driven by the second drive motor 21, the movable holder 30 receives a motive power from the second feed screw 22 which is rotating and is moved linearly in directions indicated by both arrows Y in a state guided by the third guide shaft 20.

That is, the movable holder 30 is made to be linearly movable within a range from a PBS 13 side position indicated by a solid line in FIG. 2 to a ¼ wave plate 15 side indicated by a broken line in FIG. 2.

The contact portion 31 extends by a predetermined length along the thread groove of the second feed screw 22 in a state of the contact with the second feed screw 22.

The third guide shaft 20 is for guiding the movable holder 30 for the linear movement as mentioned above, and it is placed in parallel with the linearly moving direction (i.e., the optical axis directions) of the movable holder 30.

On the other hand, the second feed screw 22 is placed to make a predetermined angle with respect to the linearly moving direction of the movable holder 30.

FIG. 3 is a cross-sectional view taken along an arrow line A-A′ in FIG. 2. As FIG. 3 shows, the movable holder 30 has a first opening portion 32 for holding the collimating lens 14 and a second opening portion 33 into which the third guide shaft 20 penetrates.

That is, the movable holder 30 is designed to be slidable with respect to the third guide shaft 20 penetrating the second opening portion 33.

Moreover, the contact portion 31 of the movable holder 30 is provided on a cantilever-like section 34 which extends toward the second feed screw 22.

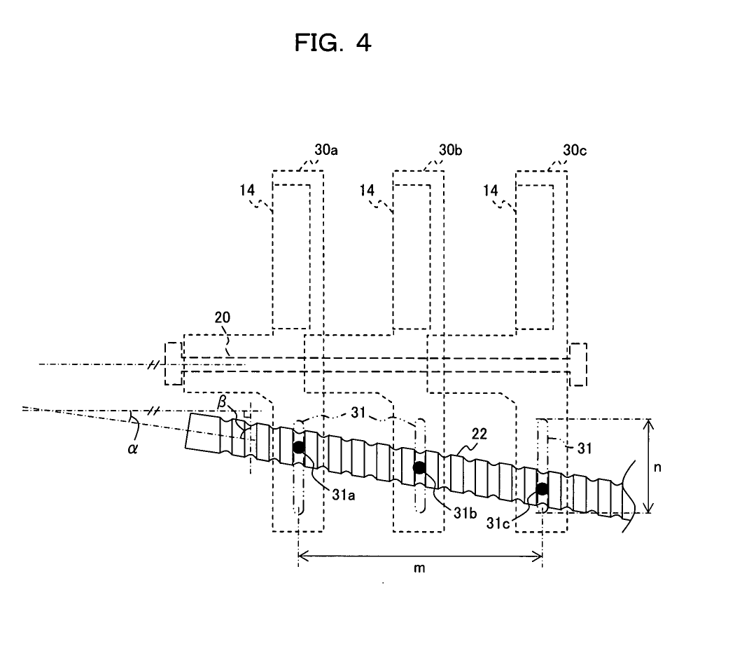

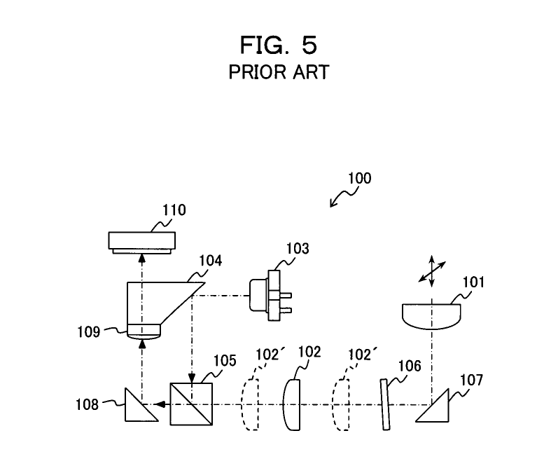

Referring to FIG. 4, a description will be given hereinbelow of a contact state of the contact portion 31 with the second feed screw 22 when the movable holder 30 is in a linearly moving condition. In FIG. 4, the movable holder 30 is denoted at a reference numeral 30a when it exists at a position (left side in FIG. 4) closest to the PBS 13, and denoted at a reference numeral 30b when it exists at an intermediate position (central side in FIG. 4) within its own movable range and further is denoted at a reference numeral 30c when it exists at a position (right side in FIG. 4) closes to the ¼ wave plate 15.

As FIG. 4 shows, the movable holder 30 is made to be capable of shuttling (or reciprocating) linearly by a distance m between the position denoted at the reference numeral 30a and the position denoted at the reference numeral 30c while holding the collimating lens 14. Since the second feed screw 22 is placed so as to make a predetermined angle α with respect to the linearly moving direction of the movable holder 30 (to the third guide shaft 20), the contact point of the contact portion 31 of the movable holder 30 with the screw thread flank of the second feed screw 22 varies in accordance with the position of the movable holder 30.

That is, the contact point of the contact portion 31 with the screw thread flank of the second feed screw 22 is a point 31a at the position denoted at the reference numeral 30a and it becomes a point 31b at the position denoted at the reference numeral 30b and it becomes a point 31c at the position denoted at the reference numeral 30c, and in accordance with the movement of the movable holder 30 from the position denoted at the reference numeral 30a to the position denoted at the reference numeral 30c, the contact point of the contact portion 31 shifts from the point 31a to the point 31c. In other words, the contact point thereof shifts from the upper side to the lower side.

Thus, since the second feed screw 22 makes a predetermined angle with respect to the linearly moving direction of the movable holder 30, the contact portion 31 extends by a predetermined length n so that the reliable contact with the screw thread flank of the second feed screw 22 takes place at any position of the movable holder 30 within the movable range.

That is, the predetermined length n of the contact portion 31 is determined on the basis of the predetermined angle α of the second feed screw 22 and the linear movement distance (movable range) m of the movable holder 30 as indicated by the equation (3) which will be mentioned later.

In addition, the direction of the thread groove of the second feed screw 22 is set to be perpendicular to or substantially perpendicular to (in this case, perpendicular to) the linearly moving direction of the movable holder 30 (i.e., the third guide shaft 20). This enhances the efficiency of the power transfer through the contact portion 31 to the movable holder 30 for the linear movement.

At this time, since the second feed screw 22 is positioned at the predetermined angle α with respect to the linearly moving direction of the movable holder 30, the angle β of the thread groove with respect to the axial direction of the second feed screw 22 is set so as to satisfy the following equation (2).

β=90°−α (2)

That is, with respect to the second feed screw 22, the screw advance (lead) angle is set so as to satisfy the above-mentioned equation (2), or the second feed screw 22 is located so as to satisfy the above-mentioned equation (2) (that is, the inclination is set at α).

In addition, the predetermined length n of the contact portion 31 is set so that the following equation (3) holds.

n≧m×tan α (3)

Thus, the contact portion 31 can come reliably into contact with the screw thread flank of the second feed screw 22 at the position of the movable holder 30 indicated by the reference numeral 30a and also at the position of the movable holder 30 indicated by the reference numeral 30c, and the movable holder 30 becomes movable along the third guide shaft 20 in a manner such that the second feed screw 22 is rotationally driven by the second drive motor 21.

As described above, with the disk drive apparatus 1 (optical head 10) according to an embodiment of the present invention, the second feed screw 22 is placed to make the predetermined angle α with respect to the linearly moving direction of the movable holder 30 and the movable holder 30 is equipped with the contact portion 31 brought into contact with the screw thread flank of the second feed screw 22 and extending along the thread groove at that contact section.

Therefore, unlike the conventional optical head, without placing the second feed screw 22 in parallel with the linearly moving direction of the movable holder 30, the movable holder 30 holding the collimating lens 14 can be reliably moved linearly in a manner such that the second feed screw 22 is rotationally driven by the second drive motor 21, which can enhance the degree of freedom of design of the optical head 10 and further can reliably and easily secure the installation space for a mechanism (in this case, the second drive motor 21) made to move the collimating lens 14 linearly along the directions of the optical axis.

That is, since the second feed screw 22 can be arranged to make the predetermined angle α with respect to the linearly moving direction of the movable holder 30 in a state where the movable holder 30 is designed to be linearly movable in the directions of the optical axis, the installation space for the second drive motor 21, which is for rotationally driving the second feed screw 22, can be changed from a place where optical elements close up in the linearly moving direction to a place where the size of the motor is enlargeable. This can facilitate the design and formation of the optical head 10.

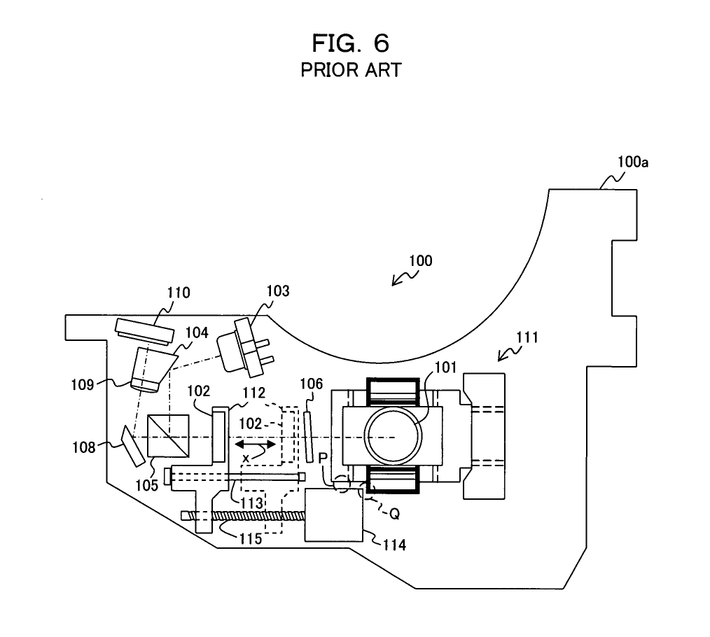

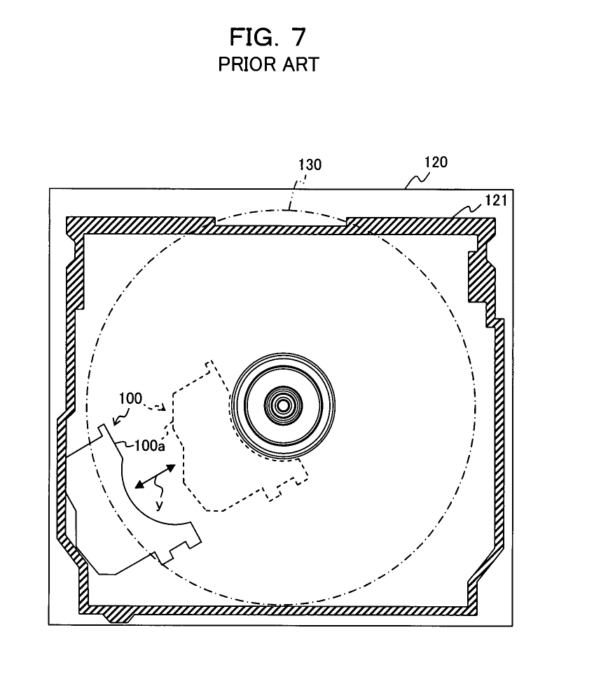

Furthermore, for example, as shown in FIG. 2, more size enlargement of the second drive motor 21 becomes feasible in comparison with the drive motor 114 of the conventional optical head 100 mentioned above with reference to FIG. 6, which develops the flexibility of torque and leads to the stable operation and high-speed operation of the movable holder 30.

Still furthermore, in comparison with the conventional optical head 100 mentioned above, the optical head 10 merely has a longer screw shaft of the second feed screw 22 and a longer contact portion 31 of the movable holder 30, so increase in cost is avoidable.

Moreover, since the length n of the contact portion 31 of the movable holder 30 is determined on the basis of the predetermined angle α of the second feed screw 22, the linear movement of the movable holder 30 along the third guide shaft 20 is reliably achievable.

Still moreover, the length n of the contact portion 31 thereof is determined on the basis of the linear movement distance of the movable holder 30, which reliably accomplishes the linear movement of the movable holder 30 along the third guide shaft 20.

More concretely, since the length n of the contact portion 31 thereof is set so as to satisfy the relation in the above-mentioned equation (3), the linear movement of the movable holder 30 becomes more reliable.

In addition, since the direction of the thread groove of the second feed screw 22 at the contacting section with the contact portion 31 is made to be perpendicular to or generally perpendicular to the linearly moving direction of the movable holder 30 or the second feed screw 22 is placed at a predetermined angle α so that the direction of the thread groove of the second feed screw 22 at the contacting section with the contact portion 31 becomes perpendicular to or generally perpendicular to the linearly moving direction of the movable holder 30, the efficiency of the power transfer through the contact portion 31 to the movable holder 30 for the linear movement becomes improvable. That is, at the rotation of the second feed screw 22, the force (transmission power) occurring due to the lead angle at the contacting section with the contact portion 31 and occurring in directions other than the feeding direction at the right angle to the axis of the second feed screw 22 is reducible, which enables the precise drive of the movable holder 30.

Still additionally, since the movable holder 30 is guided by the third guide shaft 20 for the linear movement, the movable holder 30 can be linearly moved with reliability.

In the optical head 1, the movable holder 30 holds the collimating lens 14 located between the light source (LD) 11 for emitting the laser light to be projected onto the optical disk 3 and the objective lens 16 for collecting the laser light onto the information recording layer of the optical disk 3 so that the collimating lens 14 is made to be linearly movable along the directions of the optical axis of the laser light, thereby reliably eliminating the spherical aberration occurring due to the differences at manufacturing among the cover layers, each of which forms an upper layer on the information recording layer of the optical disk 3, and due to the fact that the optical disk 3 is a blu-ray disk.

### [2] Others

It should be understood that the present invention is not limited to the above-described embodiment, and that it is intended to cover all changes and modifications of the embodiment of the invention herein which do not constitute departures from the spirit and scope of the invention.

For example, although in the above-described embodiment the direction of the thread groove in the contacting section of the second feed screw 22 with the contact portion 31 of the movable holder 30 is set to be perpendicular to or generally perpendicular to the linearly moving direction of the movable holder 30, the present invention is not limited to this, but it is also acceptable that, for a manufacturing cost reduction of the second feed screw 22 and a further increase in the degree of freedom of design, the thread groove direction is not perpendicular to the linearly moving direction of the movable holder 30. However, even in this case, the contact portion 31 of the movable holder 30 extends along the thread groove at the contacting section.

Moreover, although in the above description of the embodiment, the optical element held by the movable holder 30 is the collimating lens 14, the present invention is not limited to this and the optical element made to be linearly movable in the directions of the optical axis is not limited to the collimating lens 14.

Still moreover, the present invention is not limited in types, number and location of optical elements to be provided in the optical head 10 according to the above-described embodiment.

What is claimed is:

1. An optical head comprising:
a holder for holding an optical element;
a feed screw for moving said holder linearly; and
a drive unit for driving said feed screw,
wherein said feed screw is placed to make a predetermined angle with respect to a linearly moving direction of said holder.

2. The optical head according to claim 1, wherein a contact portion of said holder which is brought into contact with a thread groove of said feed screw is made to extend in parallel or in substantial parallel with said thread groove.

3. The optical head according to claim 1, wherein a length of a contact portion of said holder, in an extending direction of said contact portion, which is brought into contact with a thread groove of said feed screw is set on the basis of the predetermined angle and a distance of the linear movement of said holder.

4. The optical head according to claim 1, wherein a direction of a thread groove of said feed screw is perpendicular or substantially perpendicular to the linearly moving direction.

5. The optical head according to claim 1, wherein a direction of a thread groove of said feed screw is perpendicular or substantially perpendicular to the linearly moving direction, and
a length n of a contact portion of said holder, in an extending direction of said contact portion, which is brought into contact with a thread groove of said feed screw is set on the basis of the predetermined angle α and a distance m of the linear movement of said holder so as to satisfy the following equation (1)
n≧m×tan α (1).

6. The optical head according to claim 1, further comprising a guide shaft for guiding the linear movement of said holder.

7. The optical head according to claim 1, wherein said optical element is a collimating lens located between a light source for emitting laser light to be projected onto an information record disk and an objective lens for collecting the laser light onto an information recording surface of said information record disk.

8. A disk drive apparatus comprising an optical head for carrying out recording and/or reproduction of data with respect to an information record disk and a first feed screw for linearly moving said optical head,
wherein said optical head includes:
a holder for holding an optical element;
a second feed screw for moving said holder linearly; and
a drive unit for driving said second feed screw,
said second feed screw is placed to make a predetermined angle with respect to a linearly moving direction of said holder.

9. The disk drive apparatus according to claim 8, wherein a contact portion of said holder which is brought into contact with a thread groove of said second feed screw is made to extend in parallel or in substantial parallel with said thread groove.

10. The disk drive apparatus according to claim 8, wherein a length of a contact portion of said holder, in an extending direction of said contact portion, which is brought into contact with a thread groove of said second feed screw is set on the basis of the predetermined angle and a distance of the linear movement of said holder.

11. The disk drive apparatus according to claim 8, wherein a direction of a thread groove of said second feed screw is perpendicular or substantially perpendicular to the linearly moving direction.

12. The disk drive apparatus according to claim 8, wherein a direction of a thread groove of said second feed screw is perpendicular or substantially perpendicular to the linearly moving direction, and
a length n of a contact portion of said holder, in an extending direction of said contact portion, which is brought into contact with a thread groove of said second feed screw is set on the basis of the predetermined angle α and a distance m of the linear movement of said holder so as to satisfy the following equation (1)
n≧m×tan α (1).

13. The disk drive apparatus according to claim 8, further comprising a guide shaft for guiding the linear movement of said holder.

14. The disk drive apparatus according to claim 8, wherein said optical element is a collimating lens located between a light source for emitting laser light to be projected onto an information record disk and an objective lens for collecting the laser light onto an information recording surface of said information record disk.
